(19) United States
(12) Patent Application Publication
(10) Pub. No.: US 2015/0295430 A1
(43) Pub. Date: Oct. 15, 2015

(54) SMART DISTRIBUTED BATTERY SYSTEM AND METHOD

(71) Applicants: J.B. Wright, Scottsdale, AZ (US); Benjamin J. Hagan, Tempe, AZ (US); Michael James Horan, Las Vegas, NV (US)

(72) Inventors: J.B. Wright, Scottsdale, AZ (US); Benjamin J. Hagan, Tempe, AZ (US); Michael James Horan, Las Vegas, NV (US)

(21) Appl. No.: 14/434,753

(22) PCT Filed: Oct. 9, 2013
(86) PCT No.: PCT/US2013/064181

§ 371 Date: Apr. 9, 2015

Related U.S. Application Data
(60) Provisional application No. 61/795,055, filed on Oct. 9, 2012.

(51) Int. Cl. H02J 7/00

(52) U.S. Cl. CPC H02J 7/0021; H02J 7/007

(57) ABSTRACT

A system of replaceable and configurable battery power modules (BPMs) operatively connected to a smart management module (SMM) is provided. Each BPM can include a plurality of battery cells (e.g., Lithium) wired together in series and/or parallel. The BPMS are independently capable of cell balancing, monitoring and recording critical information about cell performance. The BPMs, wired together in series and/or parallel are connected to the SMM to form a cumulative battery pack. The performance and control limit information from each BPM can be used by the SMM to properly control the charging and discharging of the complete battery pack.

### PRIORITY AND RELATED APPLICATIONS

This application claims priority to and the benefit of U.S. Provisional Patent Application No. 61/795,055, filed Oct. 9, 2012, which is incorporated herein by reference in its entirety.

### FIELD OF THE INVENTION

The present invention relates generally to battery systems, and more particularly, to a distributed system having a plurality of battery power modules to define a smart battery system providing detailed feedback, flexible configurations, upgrades and repairs.

### BACKGROUND OF THE INVENTION

Most battery-powered product reviews show that battery performance is the weak link to having a good and reliable product. When products like Light Electric Vehicles (LEVs) are configured with battery packs to power motors it requires several battery cells in a battery pack, and the pack is only as good as the weakest cell. The battery packs are monolithic, with all cells provided within a single pack, and there are currently no viable methods for diagnosing faulty battery packs, and the repair and replacement becomes futile as existing battery chargers and systems treat all of the cells within the battery pack the same. As a result, the current systems do not allow for selective diagnosis, repair or replacement of individual cells.

As such, while it is true that in many cases the majority of the cells within the battery pack may be good and functional, the entire battery pack is discarded or thrown into the trash. The good cells are discarded with the few bad cells. Such a practice is obviously problematic as it introduces unnecessary costs and contributes to waste. And while some battery technology has improved over the years, it still includes a central battery management system that treats all battery cells the same for charging, discharging, and protection.

Further, lithium-ion batteries rated with greater than 100 WH of power are presently classified as class 9 hazardous materials, which imposes severe restrictions and costs on shipping and transportation of such batteries within the U.S. and internationally. These are the types of batteries currently being employed in electronic vehicles and many other applications outside small consumer goods. Consequently, even though only a single or limited number of cells may in fact be faulty within the overall battery pack, the end user or vehicle dealer is forced to have the entire monolithic battery pack shipped back for repair, or have another similar pack shipped in as a replacement. The costs and regulatory restrictions associated with these shipments can be prohibitive.

Consequently, there is a need for a smart battery system having a plurality of battery power modules capable of flexible and selective configurations, upgrades and repairs.

### SUMMARY OF THE INVENTION

The present invention's Battery Management System (BMS) functions are divided between those that can be performed by an individual Battery Pack Module (BPM) and those that are performed by a Smart Management Module (SMM) in operative communication with and control of a plurality of individual BPMs.

The present invention can include cost reduction methods that make the system commercially viable using small BPMs of less than 100 WH. The system can be easily scaled for larger power modules and battery packs, providing improved profit margins compared to systems presently being utilized.

There are many misconceptions about conventional battery systems. For instance, it is often assumed that battery systems operate under and maintain a constant voltage source, maintain the operating behavior over the lifetime of the batteries in a simple, linear system. This is incorrect, and embodiments of the present invention provide a highly modular and selectively configurable system that can detect, account for, and modify system behavior based on the changes or degradation of battery modules to optimize performance and minimize costs.

The modular nature of the system simplifies configuration changes. Changes are often required for maintenance, allowing the system to continue working while individual modules are being repaired. This can greatly reduce down time. Another aspect area supported with this modular system is where performance requirements change frequently. Being able to change the voltage with BPM units in series is one way to meet changing performance requirements. The ability to parallel more BPM units can be a way to meet changing performance for current demand or length of run time, e.g., amp-hour changes.

The system will work with and interactively and dynamically adjust for battery cells and modules that are not closely matched in terms of performance, life cycle, and the like. Further, each BPM within the system will contain vital information that can be processed and utilized to optimize and even extend the life of the individual BPMs and the corresponding cells. In addition, the system information recorded at the BPMs and processed and configured at the SMM can protect, monitor and control the operation and limits of the BPMs in accordance with programmed instructions and/or with user adjustable configurations.

The BPM is the building block for larger power packs for use in many electronic products, including LEVs. Each BPM can include a module controller and one or more battery cells. The controller can be provided on a circuit board with the BPM. As such, each system can include a plurality of BPMs, each having its own controller.

The controller of the BPM can include a self-contained processor, sensors, one or more sensor ADCs, memory, and output which can include a plurality of lines for outputting the sensed and/or stored and processed module data for communication with the SMM via a communication port. In addition to directing the storage of detailed information about the BPM and its cells, the processor is configured to retrieve, and process and perform computations on, data from the sensors at the respective BPM, and store the data to the memory for later retrieval and use by the SMM and/or a user configuration device.

The SMM extends the current and voltage protection (over- and under-) to the distributed battery cells in the system beyond that provided by traditional battery management systems. The SMM comprises a processor that uses communication software and/or hardware logic to monitor and dynamically modify the BPMs, enabling it to make intelligent changes to traditionally static parameters. A communication port provided with the SMM provides communication from the SMM to the BPMs via a data or bus line. The SMM can further comprise memory.

The SMM can receive pack voltage, pack current, temperature, pressure sensor data, and can detect if the charger is present and whether a load is present. Sensors can be configured to sense moisture, as a strain gauge, an accelerometer, a gyrometer, and the like. This and other data or information can be gathered to create SMM status. Combined with user configurable control limits and configuration data, the processor can perform various operations or processing outputs. For instance, the SMM can directly control or output to an electronic fuse control, output to an active temperature control, output to discharge or output to charge, or output for pulse width modulation (PWM) charging. For instance, the PVM charge allows for the use of a charger having larger voltage output than the pack voltage of the combined BPM cells. The user can simply use the system with minimal interaction or configuration input, or the user can interact greatly via the devices and methods described herein to extensively configure and monitor specific aspects of the system, and the system in general.

User interaction and configurability for the system is also an aspect of the present invention. A software application, or hardware logic, installed on a personal computer, a mobile device, or a remote server can communicate through a wired (e.g., USB, Ethernet, etc.) or wireless interface (e.g., Bluetooth, Wi-Fi) with the SMM, or the BPMs directly in certain embodiments, to provide useful information to the user, dealer, repair center and/or manufacturer. The user connectivity and interface can further allow the user to selectively control and configure the system. The SMM can receive commands from the user connection to send, store/save, and configure operating limits and parameters for the system.

### BRIEF DESCRIPTION OF THE DRAWINGS

FIG. 1 is hardware diagram of a smart distributed, modular battery system architecture, in accordance with embodiments of the present invention.

FIG. 2 is a schematic block diagram software and hardware of a battery pack module and control system, in accordance with embodiments of the present invention.

FIG. 2A is a schematic block diagram of a battery pack module and its components, lines, and cells, in accordance with embodiments of the present invention.

FIG. 3 is a flow diagram of a battery pack module initialization and execution thread, in accordance with embodiments of the present invention.

FIG. 4 is a flow diagram of battery pack module processing based on commands received from a smart management module, in accordance with embodiments of the present invention.

FIG. 5 is a flow diagram of a battery pack module state machine to monitor and control cell voltage, in accordance with embodiments of the present invention.

FIG. 6 is a flow diagram of a battery pack module state machine to monitor and control cell temperature, in accordance with embodiments of the present invention.

FIG. 7 is a schematic block diagram of hardware and software of a smart management module and control system, in accordance with embodiments of the present invention.

FIG. 7A is a schematic block diagram of a smart management module and its components, lines and connectivity to battery power modules, in accordance with embodiments of the present invention.

FIG. 7B is a schematic block diagram of a smart management module in a system without individual battery power modules, in accordance with embodiments of the present invention.

FIG. 8 is a flow diagram of a smart management module initialization and execution thread, in accordance with embodiments of the present invention.

FIG. 8A is a schematic diagram of a smart management module, with initialization, normal and protection modes, in accordance with embodiments of the present invention.

FIG. 9 is a schematic diagram of a user and augmented user operation of a smart distributed, modular battery system, in accordance with embodiments of the present invention.

FIG. 10 is a schematic diagram of user operations of a smart distributed, modular battery system to configure, update, test and perform analysis, in accordance with embodiments of the present invention.

FIG. 11 is a schematic diagram of a user directly interacting with a smart management module, in accordance with embodiments of the present invention.

FIG. 12 is a schematic diagram of a user directly interacting with a battery pack module, in accordance with embodiments of the present invention.

FIG. 13 is a flow diagram of user application processing for a smart distributed, modular battery system, in accordance with embodiments of the present invention.

FIG. 14 is a schematic diagram of a server side database map for a smart distributed, modular battery system, in accordance with embodiments of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION OF PREFERRED EMBODIMENTS

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention.

The acts, modules, logic and method steps discussed herein, according to certain embodiments of the present invention, may take the form of a computer program or software code stored on a tangible or non-transitive machine-readable medium (or memory) in communication with a control device, comprising a processor and memory, which executes the code to perform the described behavior, function, features and methods. It will be recognized by one skilled in the art that these operations, structural devices, acts, logic, method steps and modules may be implemented in software, in firmware, in special purpose digital logic (e.g., Field Programmable Gate Arrays (FPGAs) or Application Specific Integrated Circuits (ASICs)), custom electronic circuits (hardware), and any combination thereof without deviating from the spirit and scope of the present invention as recited within the claims attached hereto.

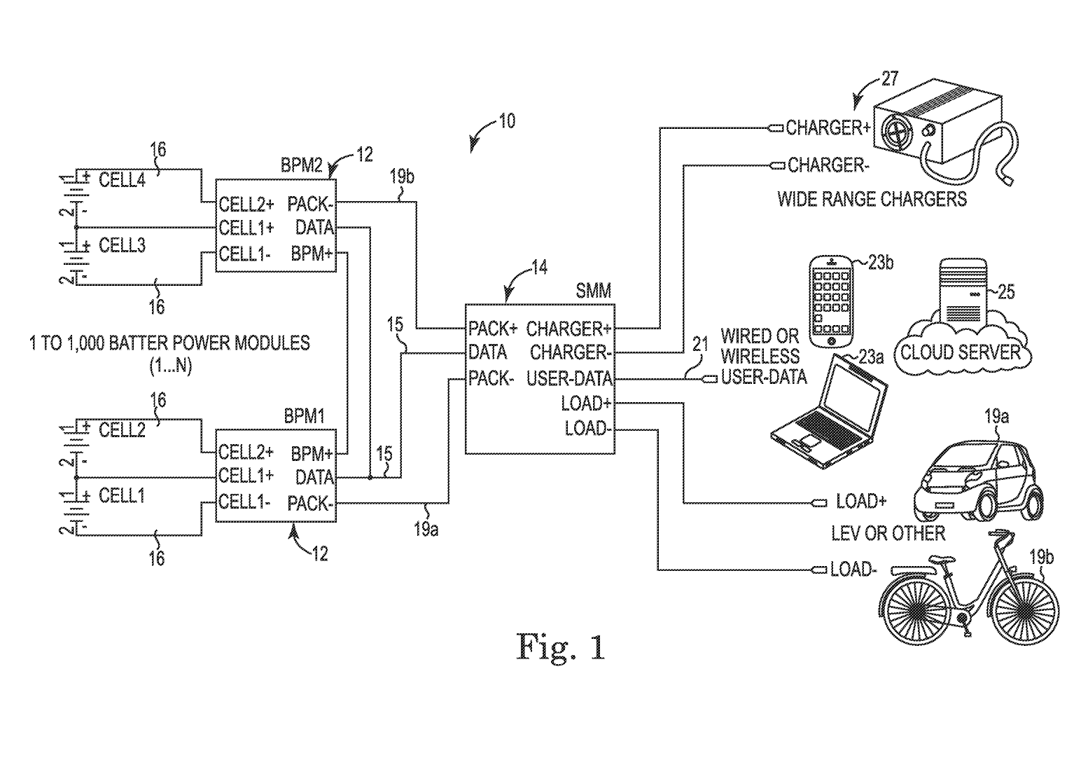

Referring generally to FIGS. 1-14, the present invention comprises a system 10 and method for employing a plurality of battery power modules (BPMs) to build a larger battery power system, thereby allowing for flexibility in configuring, monitoring/sensing, upgrading and repairing larger battery systems. A plurality of BPMs and the corresponding cells comprise a “pack”—e.g., the sum of BPMs/cells in the system. The system 10 includes one or more smart BPMs 12 and a smart management module (SMM) 14. Each BPM 12 senses, stores, processes, and communicates valuable information to the SMM 14. The modules can include a solder-free flexible configuration method for constructing larger and high-powered battery packs.

In various embodiments, the present invention's battery management functions are divided between those that can be performed by the individual BPMs and those that can or must be performed at the level of the aggregate battery pack by a SMM. In addition, various functions can be selectively performed by the BPMs and the SMM, depending on urgency or prioritized processing decisions at the BPMs or SMM.

The invention includes cost reduction methods that make the system commercially viable using smaller, <100 WH, BPMs. The system 10 can be easily scaled for larger power modules and battery packs, providing improved profit margins and ease-of-use compared to conventional systems.

FIG. 1 shows a schematic diagram of the system 10 having one or more BPMs 12 (e.g., BPM 1 . . . BPM N), a data or bus line 15, and a single SMM 14. There is a negative and a positive battery connection for the high current flow from each BPM 12. The BPM with the most negative potential is connected via line 19a to the negative connection of the SMM 14. Additional BPMs are connected in series and/or parallel to provide the total voltage and amp-hour capacity that a user needs for a particular system or application. The most positive potential from the BPMs is connected via line 19b to the positive connection of the SMM 14. Again, the aggregate BPMs from this most negative potential to the most positive potential comprise the “pack” for the system.

Based on the current updated status of the BPMs as they are configured or reconfigured at any given time, the SMM monitors information or data received from the BPMs and sets the protection method and limits for the battery pack. This information is used to protect the battery and generate estimates for accurate state of charge information for each BPM 12. The overall battery pack health is accessible by wired or wireless communication input/output port 21 for communication with a personal computer 23a, or a mobile device 23b (e.g., smartphone, tablet or the like), running compatible software or an application. The information received can be displayed graphically or textually for the user and can be stored in an internet-based server side database 25 (e.g., cloud server) for quality control tracking by the manufacturer, supply chain entities, and others. In certain embodiments, the input/output port 21 can provide a USB connection, a Bluetooth connection, and other wired and wireless protocols known to one of ordinary skill in the art.

The dynamic and constant nature of the monitoring and processing of the system data and records promoted preventative maintenance and the detection of field issues (e.g., negative events) quickly, accurately and efficiently.

The system 10 and SMM 14 are able to work with a wide range of battery chargers 27, and the SMM 14 is configured and programmed to turn the charger 27 on & off based on a collection of information and processed data from the operatively connected BPMs.

Connection to the load 31 of the system 10 can include a variety of vehicles and devices adapted to receive the power from the aggregate battery pack. For instance, LEVs 19a, e-bikes 19b (scooters or motorcycles), and a myriad of other vehicles or devices can implement the system 10 and its modular and configurable benefits. In certain embodiments, the system 10 can be employed with scooters running at 60V, with 10 BPM units in series. Electric motorcycles implementing the system may use 72V, with 12 BPM units in series, or up to 90V with 15 units in series. Moreover, electric motorcycles can have between 2 to 5 parallel sets of BPM units (e.g., 12 BPMs×2 sets=24 units, up to 15 BPMs×5 sets=75 units). Other target applications include portable medical and industrial devices, grid storage, servers, and the like. Of course, other vehicles, devices, and applications, are envisioned for use with embodiments of the system 10 without deviating from the scope of the invention.

The system 10 will work with and interactively adjust for battery cells and modules that are not closely matched in terms of performance, life cycle, and the like. Further, each BPM within the system 10 will contain vital information that can be processed and utilized to optimize and even extend the life of the individual BPMs. In addition, the system 10 information recorded at the BPMs and processed and configured at the SMM can protect, monitor and control the operation and control limits of the BPMs in accordance with programmed and/or user-adjustable configurations.

### Battery Power Module

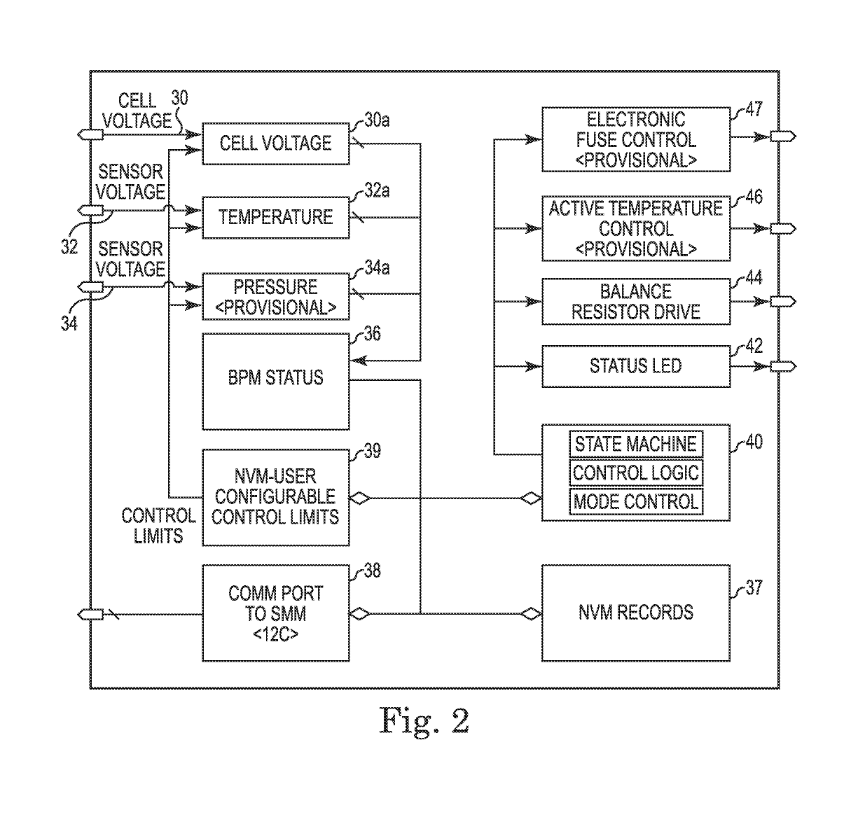

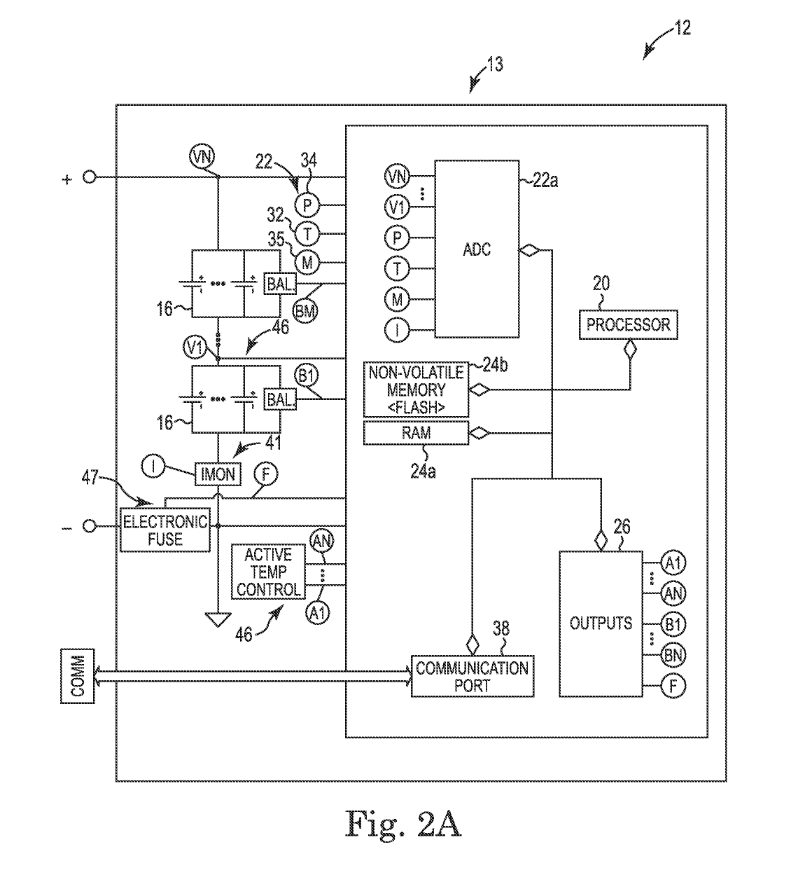

Referring generally to FIGS. 2-6, the BPM 12 is the building block for larger power packs for use in many electronic products, including LEVs. Each BPM 12 can include a module controller 13 and one or more battery cells 16. The controller 13 can be provided on a circuit board with the BPM 12. As such, each system 10 can include a plurality of BPMs 12, each having its own controller 13.

The controller 13 can include a self-contained processor 20, sensors 22, one or more sensor ADCs 22a, memory, and output 26 which can include a plurality of lines for outputting the sensed and/or stored and processed module data for communication with the SMM via the comm port 38. The memory can include a RAM memory 24a and a non-volatile flash memory 24b component. In addition to directing the storage of detailed information about the BPM and its cells 16, the processor 20 is configured to retrieve, and process and perform computations on, data from the sensors 22 at the respective BPM, and store the data to the memory for later retrieval and use by the SMM 14.

An exemplary processor 20 for certain embodiments can include the model MSP430G2231 processor from Texas Instruments, a low cost 8-pin device. Obviously, other processors, and/or hardware logic, can be employed with other embodiments of the present invention without deviating from the scope of the present invention.

In general, the BPMs 12 can perform the following functions and tasks in certain embodiments: modular identification tracking (e.g., unique identifier information for each module and/or cell), balancing voltage and providing over-voltage and under-voltage protection, temperature limit enforcement, two-way communication with the SMM 14, and the storage and communication of vital control limit data.

Such data can be stored in non-volatile memory 24b at the controller 13 as BPM records 37, and can include general operating or control limits and information for the BPM, including the serial number, BPM type, date of manufacture, and ratings for the cycle life, voltages limits (over-voltage, under-voltage, voltage requiring balance resistor, voltage turning off balance resistor), current limits (over-current in charge and discharge direction, taper current, and standby minimum current), amp-hour capacity, temperature limits (over-temperature and under-temperature), and allowable persistence or the time period allowed for any excessive ratings or readings to exist. Further, particular sensed data after installation and/or use of the BPM can be stored in the records 37 as well, including calibration data, the state of charge (e.g., charge left within a current discharge cycle), the state of health (e.g., “SOH”—the current capacity of the battery, which can degrade over time), the cycle life of the battery, and fault records of adverse events.

The block diagrams of FIG. 2-2A demonstrate the various hardware and software functions and operational methods of an individual BPM 12 for embodiments of the present invention. Inputs of the BPM 12 are in operative communication with the controller 13 and can include a cell voltage input 30, a temperature sensor voltage input 32, a current monitor 41, a pressure sensor voltage input 34, and a sensor 35. Sensor 35 can be configured to sense moisture, as a strain gauge, an accelerometer, a gyrometer, and the like. As a result, data values for cell voltage 30a, temperature 32a, pressure 34a, and the like, are stored in memory as the BPM status 36. The BPM status 36, along with the other information and data, such as record data 37, as described herein, can be communicated to the SMM 14 via the comm port 38 along data line or bus 15. Analog-to-digital conversion at the inputs can use multi-function pins that measure cell voltage and drive I/O for protection circuitry. The data outputted to the SMM 14 from the BPMs 12 can occur based upon receiving a direct request from the SMM 14, or in accordance with predefined or selective timing by the BPM 12 executed at the processor 20. V1 indicates the cell voltage at a first cell of the particular BPM up to N number of cells at voltage VN.

The processor 20 of the controller 13 can process and direct the record data 37 and BPM status 36, or other data, at processing state 40. In addition, the processor 20 can output to a status LED 42 to visually indicate the present mode (e.g., active mode, low power mode, or idle mode) or to indicate that a balancing resistor has been initiated, output to and drive the balance resistor at 44 to regulate balanced charging of the BPM 12, output to and drive a fan, liquid or other heating or cooling devices at 46 based on processed temperature data from input 32, and output to an electronic fuse control at 47. In addition, user configurable control limits and parameters 39 can be inputted and received by the BPM 12 (e.g., from the SMM or inputted to the BPM directly), as described herein.

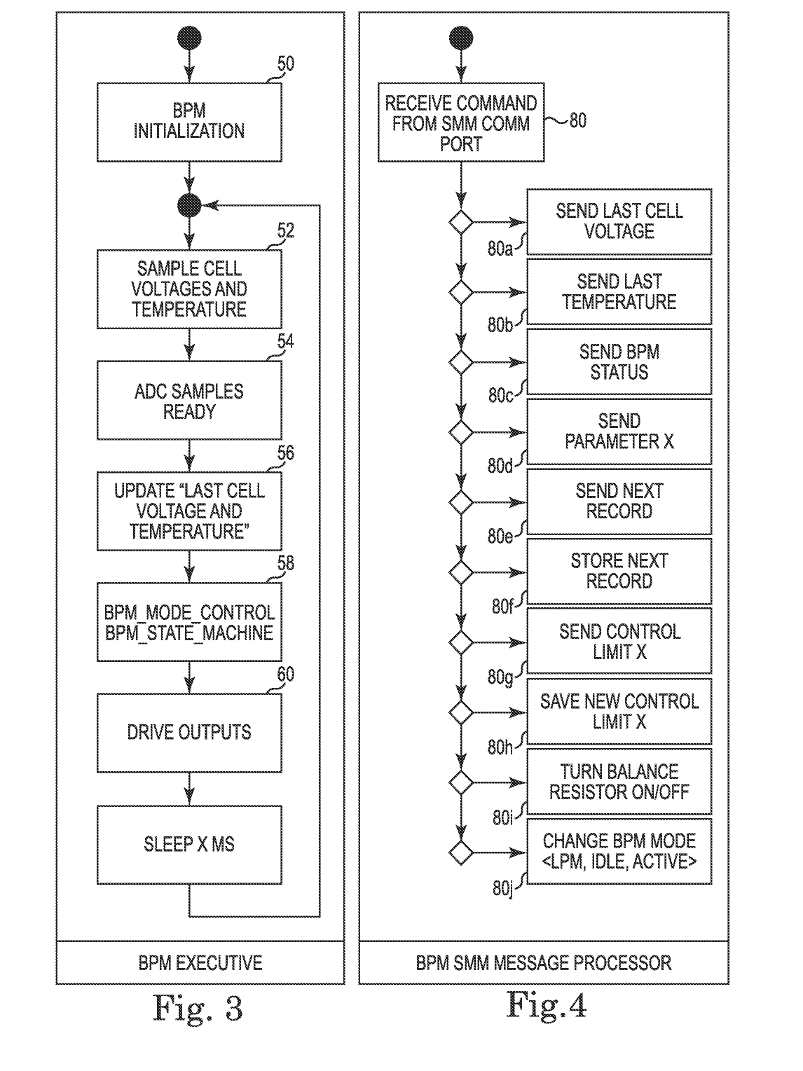

FIG. 3 is a diagram of exemplary executive steps at the controller 13 of the BPMs 12. In general, the processor 20 runs through the steps periodically—e.g., approximately every 500 milliseconds. The timing is configurable and can vary greatly depending on the particular application needs and data involved. First, the BPM is initialized at step 50, which can bring the BPM 12 out of a sleep, idle or other state. Next, the controller 13 samples the inputs described herein (e.g., 30-34) at step 52, readies the sample data at step 54, filters values from the sample data to create the last read (e.g., most recent) cell voltage and temperature data at step 56, performs state machine operations at step 58, and drives outputs at step 60—including initiating the balance resistor at 44, driving the status LED at 42, driving the temperature control output at 46, etc.

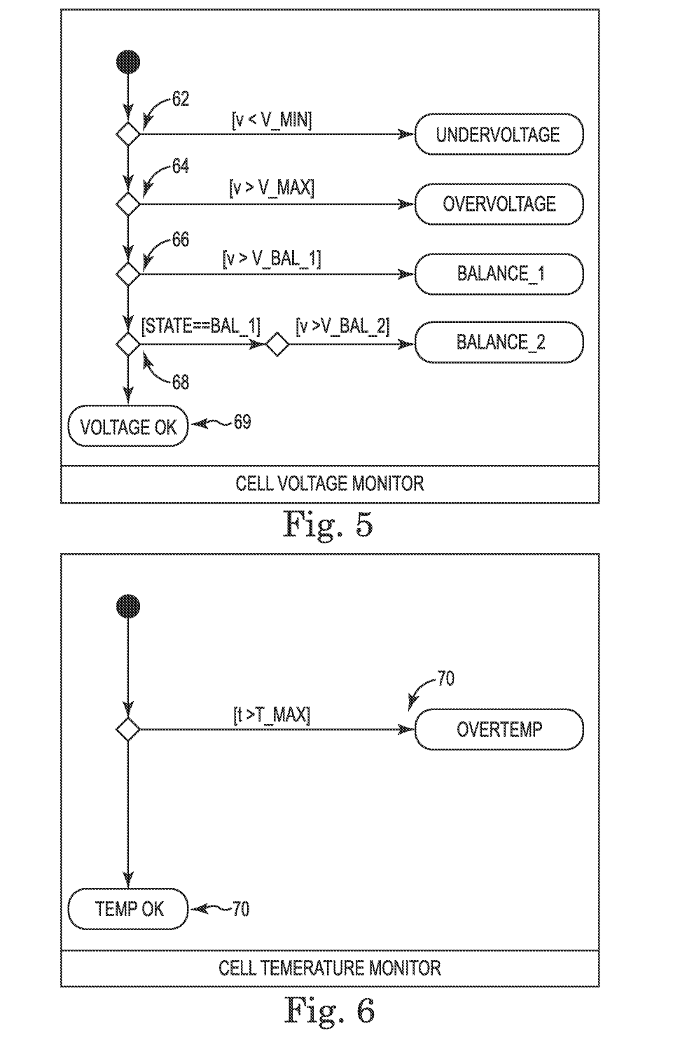

The state machine processing of step 58 can include a myriad of processing operations performed by the controller 13 via the processor 20, including temperature monitoring, voltage monitoring, current monitoring, and the like. In certain embodiments, as shown in the diagram of FIG. 5, a cell voltage monitoring operation is performed. Namely, the cell voltage data 30a is monitored and the processor 20 determines if the data 30a is under-voltage at step 62, or over-voltage at step 64. The balance resistor drive 44 is controlled to balance the voltage at charging by selectively turning the balance resistor on and off as needed. Step 66 indicates the driving or turning on of the balance resistor, and step 68 indicates turning off the balance resistor, to achieve the desired voltage. If the cell voltage 30a is within the operating parameters, cell voltage is indicated as being acceptable at 69 and driving of the balance resistor is not needed.

Similarly, the state diagram of FIG. 6 shows a cell temperature monitoring operation, wherein the temperature value 32a is monitored. If the temperature is within the operating or control limits, the cell temperature is indicated as acceptable at 70. If the value 32a is over the acceptable or preferred operating temperature at 71, the processor 20 can initiate the active temperature control output 46 to cool down the cell within the BPM 12, or store the event in memory for communication to the SMM 14.

As demonstrated in FIG. 4, the BPM 12 can a receive command 80 from the SMM (e.g., via line 15). The SMM command 80 can include a myriad of send and store/save commands for the BPM 12. For instance, the command 80 can include a request for the BPM to send the last cell voltage data at step 80a, send the last temperature data at step 80b, or send the BPM status data at step 80c. Further, the SMM command 80 can include a request for other parameter data (e.g., parameter x) at step 80d (e.g., pressure data, current data, external BPM temperature data, vibration data, and the like), and it can request next record data at step 80e and control limit data from the BPM at step 80g. The command 80 can also instruct the BPM 12 to store data from the SMM 14, such as next record data at step 80f, new control limit data at step 80h, and it can instruct the BPM 12 to turn the balance resister on or off at step 80i, or to change the BPM mode (e.g., low power mode, idle mode, or active mode) at step 80j. Other send, store and/or process instructions from the SMM 14 to the BPM 12 are envisioned and can be employed within the system 10 without deviating from the scope of the present invention.

In order to reduce current draw between charges, and to extend operation life, the processor 20 of the BPM 12 can operate in the low power mode when the battery is not being charged or discharged.

The following table provides exemplary features, terminology, and use cases for the BPM 12, including features and use cases for sensing/monitoring the cells and pack, storing data received from the cells and pack in memory, processing data received from the sensing/monitoring at the processor, and communicating data and information to the SMM (e.g., host) or user. The features and use cases can be performed via the software and/or hardware detailed herein.

| Feature/Use Case ID | Feature/Use Case Description |
|---|---|
| Monitor V and T | Monitor battery cell voltage and temperature. Sample ADC pins, |
| | filter, and provide value to rest of program. |
| Protection Algorithms, | Protect for over-voltage, under-voltage, over-temperature. Update |
| BPM status | BPM status. |
| BPM State | State of BMP |
| Power Mode Policy | 3 basic modes - low power, idle, and active. Powers up in Low |
| | Power. SMM controls transitions to the different states. |
| Save * Record from | Fault record, a control limit, or a health/life record. |
| SMM | |
| Send * Record To SMM | Fault record, a control limit, or a health/life record. Stored on the |
| | BPM. The host can request a read of all records, or a read and |
| | erase. |
| Send * Data/Status to | Generally, BPM status, cell voltage, and temperature. |
| SMM | |
| I2C | The communication or bus line that the BPM provides to |
| | communicate with the SMM. |
| NVM - Module | Non-volatile memory section. Personality information to uniquely |
| Identification | define a BPM, as well as information about its type. Can include |
| | data for the BPM's globally unique serial number, BPM type |
| | (defines chemistry, cell configuration, default control limits, rated |
| | capacity), initial capacity from manufacturing, etc. |
| NVM - Life Data (Health) | Non-volatile memory section. This includes data for the last |
| | measured SOH, which is the current capacity of the battery. The |
| | BPM does not need to determine its health to update these |
| | records. The SMM can determine the BPM's health and will write |
| | new records to this section of memory. |
| Calibrate/Test ADC | Calibrate and test analog-to-digital converter(s) |
| NVM - Failure/Fault | Non-volatile memory section. SMM can write to this section of |
| Records | memory because the BPMs may not have all required resources to |
| | generate a failure record (such as real time clock or a synchronized |
| | system clock). |
| NVM - Control Limits | Non-volatile memory section. Stores the current control limits, |
| | which are determined by host. Example control limits are: under- |
| | voltage (VUV), over-voltage (VOV), balance resistor on voltage |
| | (VBON), balance resistor off voltage (VBOF), over-current (IOC), |
| | over-temperature (TOT), etc. |
| BPM Initialization | Initialize ADCs, discrete inputs, discrete outputs, timers, and |
| | global/static variables. Set BPM to low power mode. |
| SaveToFlash | Store data or records to BPM's non-volatile memory. Any type of |
| | data can be stored. The flash manager will manage the details of |
| | flash memory, with user specifying the section of memory they |
| | want to access. |
| ReadFromFlash | See SaveToFlash. |
| Balance Resistor On/ | A driver translating a logical on/off command to the physical world. |
| Off | The output could be an I2C GPIO. Or there may be special timing |
| | aspects to consider (turn on/off delay). |
| LED On/Off | See Balance Resistor On/Off - visual indicator of such. |
| BIT | Built In Test. There are several types - initiated (IBIT), periodic |
| | (PBIT), continuous (CBIT), and at power-up (PUPBIT). |

### Smart Management Module

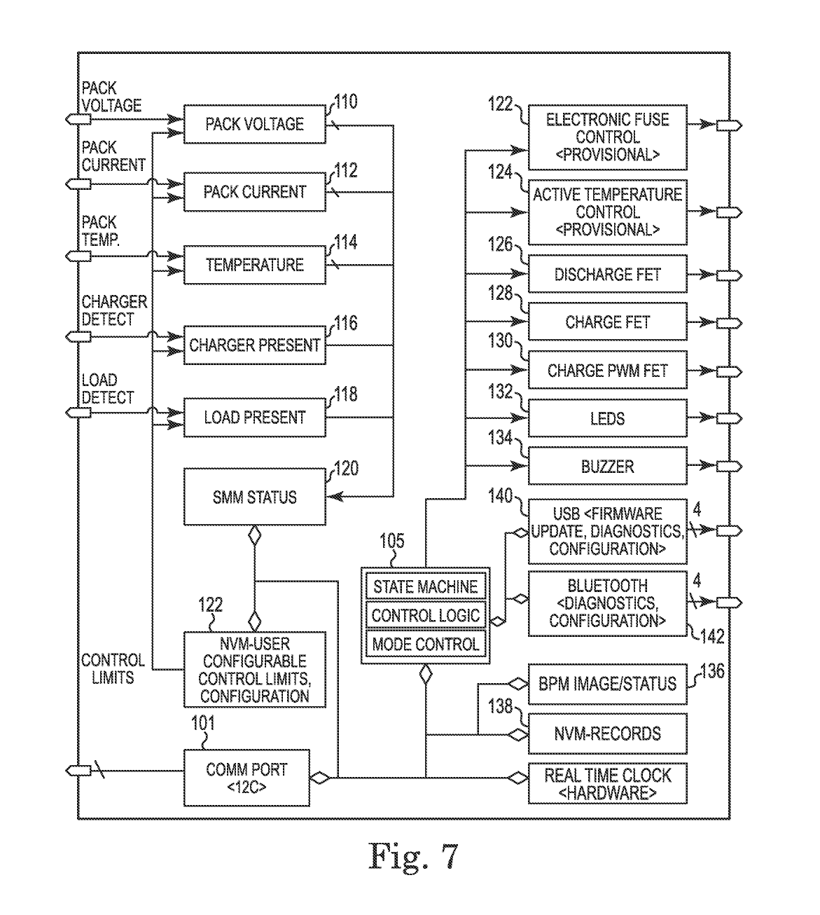

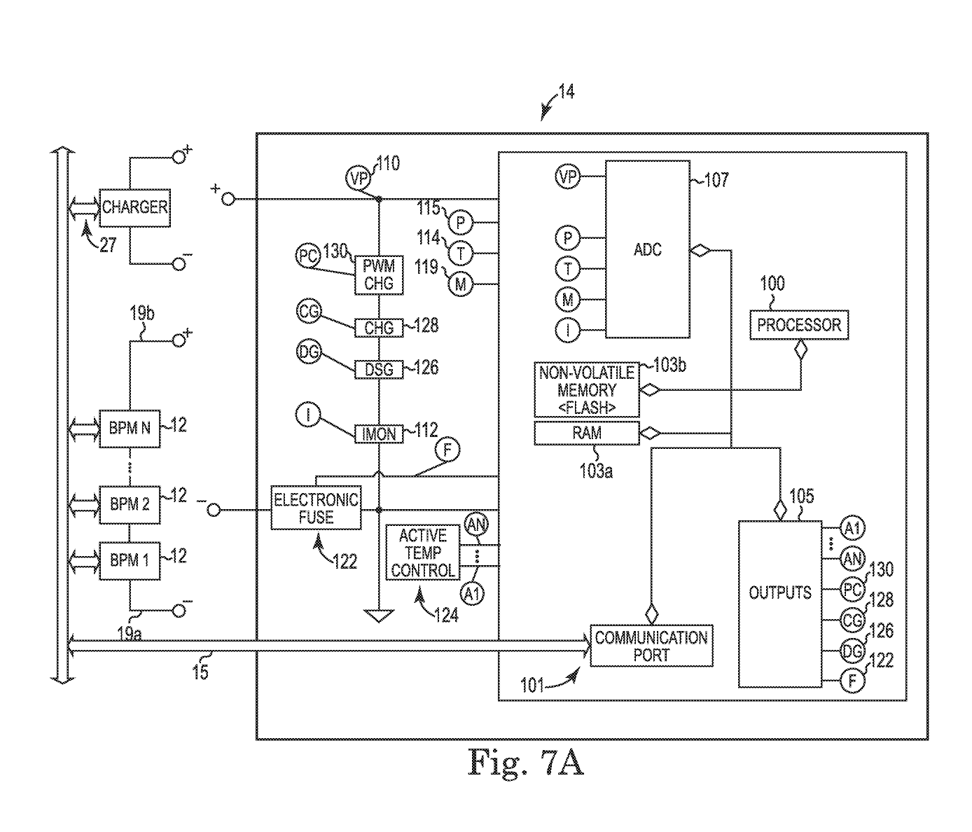

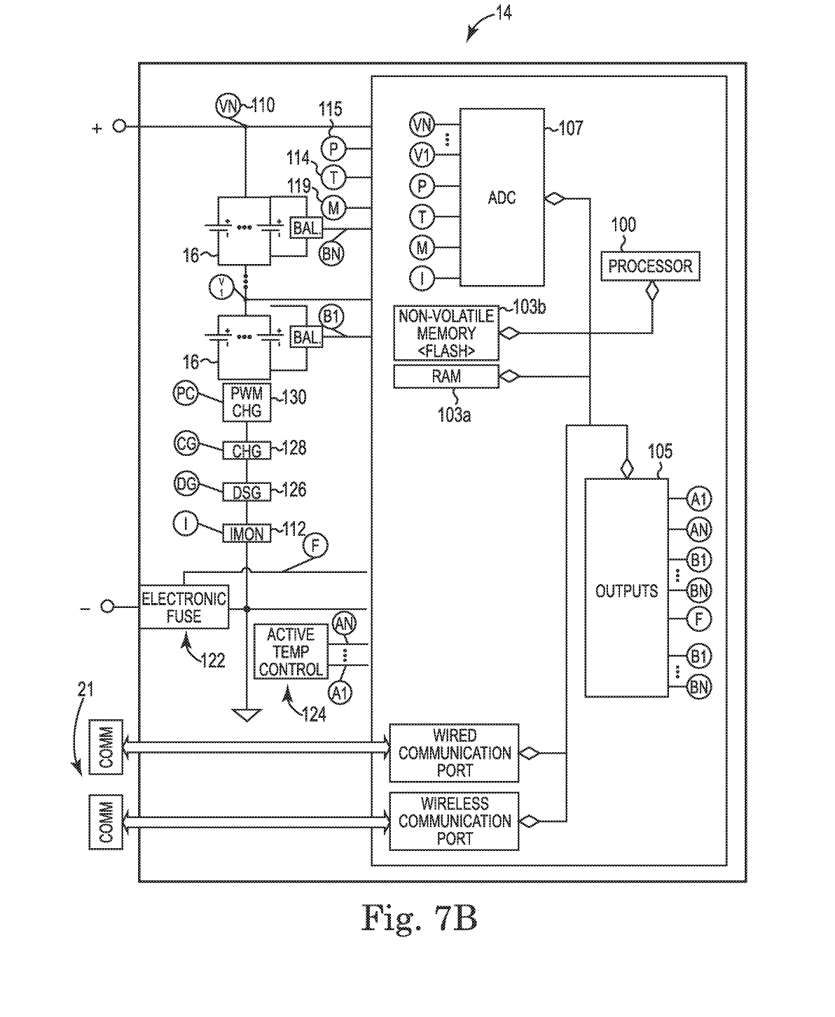

Referring to FIGS. 7-7B, the SMM 14 extends the current and voltage protection (over- and under-) to the distributed battery cells in the system 10 beyond that provided by traditional battery management systems. The SMM 14 comprises a processor 100 that uses communication software to monitor and dynamically modify the BPMs, enabling it to make intelligent and dynamic changes to traditionally static parameters. A communication port 101 can provide communication from the SMM 14 to the BPMs via the data line 15. The SMM 14 can further comprise memory, including RAM memory 103a and/or non-volatile memory 103b.

The block diagrams of FIGS. 7-7A demonstrate the various hardware and software, functions and operational methods of the SMM 14 for embodiments of the present invention. Via inputs, such as through one or more analog-to-digital converters 107, the SMM 14 can receive pack voltage 110, pack current 112, temperature 114, pressure sensor data 115, and can detect if the charger is present at 116 and whether a load is present at 118. Sensor 119 can be configured to sense moisture, as a strain gauge, an accelerometer, a gyrometer, and the like. This and other data or information can be gathered to create SMM status 120. Combined with user configurable control limits and configuration data 122, the processor 100 can control various operations or outputs 105. For instance, the SMM 14 can directly control or output 122 to the electronic fuse control, output 124 to the active temperature control, output control 126 to discharge or output control 128 to charge, or output 130 for pulse width modulation (PVM) charging. The charge PVM 130 allows for the use of a charger having larger voltage output than the pack voltage. For instance, a 48 volt charger can be used with a 24 volt pack (aggregate voltage for all BPMs) via the charge PVM 130 in certain embodiments. Other configurations and parameters for using chargers of differing voltage outputs compared to the pack voltage are envisioned for use as well.

The processor 100 can also output to an LED, or LEDs, at 132, or to an audio buzzer at 134. These visual and audio outputs can be used to provide sensory feedback and information to the user, such as BPM faults, initiation of balance resistor, mode status, charging, and the like. Again, like the BPMs, the SMM 14 can process and store BPM image and status data 136 and record data 138 (e.g., BPM records 37 amended or non-amended).

Further, as shown in FIG. 7, users can interact and configure the SMM 14 via USB 140 and/or Bluetooth 142 connections. Obviously, other wired or wireless standards or communication protocols can be employed to facilitate communication with the SMM 14 without deviating from the scope of the present invention.

The SMM 14 communicates with each BPM 12 via the data line or bus 15 to receive status information and other metrics, and to instruct the BPMs to send data, or store data in memory. Status and other data or information received from the BPMs, as described herein, can include BPM identification information, voltage levels, temperature data, most recent levels, control limits, and the like. The SMM 14 then processes this information to assess the health and life status of each BPM 12. If adverse health information is detected for a particular BPM 12 in a pack, the SMM 14 can instruct that BPM 12 to break the flow of current to the BPM to prevent further damage or degradation.

Upon power up, the SMM 14 initiates an enumeration sequence that queries each BPM 12 in order to build an image of the BPM network or pack. Each BPM 12 sends data to the SMM 14 via the data line 15, as described herein. For instance, the SMM 14 can request each BPM 12 to send initial test result data, calibration data, the number of charge cycles, voltage extremes, power usage, and the like. If any of the configured BPMs do not respond, or if any BPM reports an error, the SMM may disable the system 10 as a fail-safe and may alert the user via the outputs described, or an operatively connected computer or mobile device. The SMM 14 can measure the total current flowing through the BPMs as well as the system voltage—e.g., from the most negative BPM terminal 19a to the most positive BPM terminal 19b.

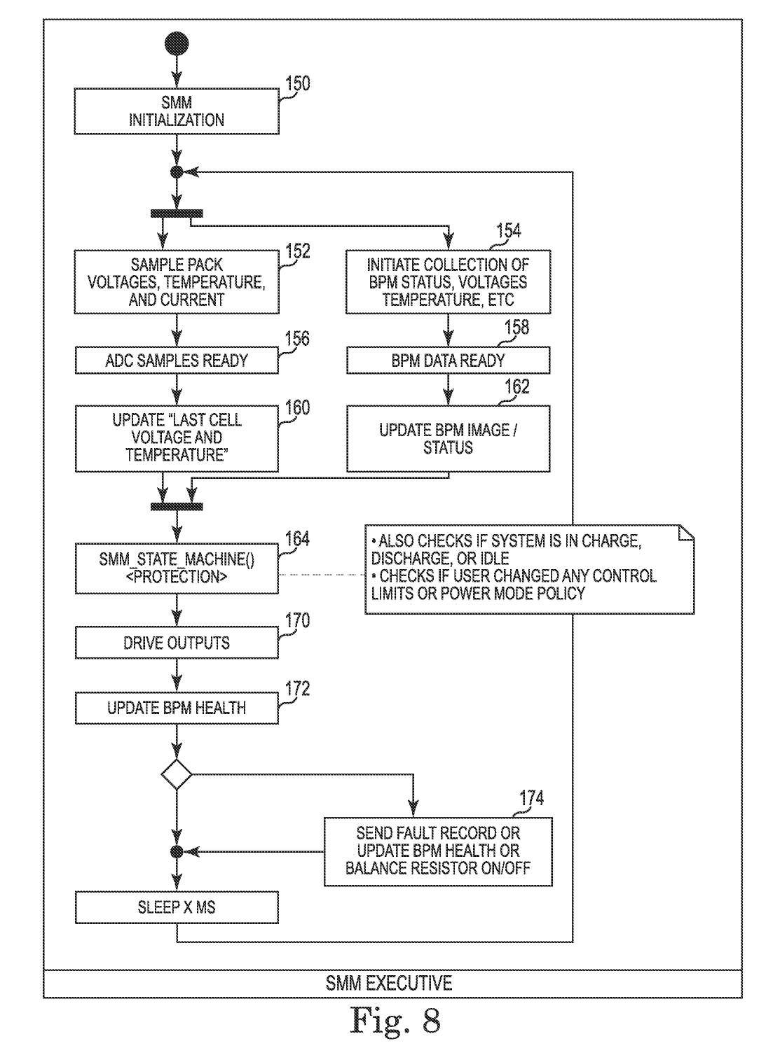

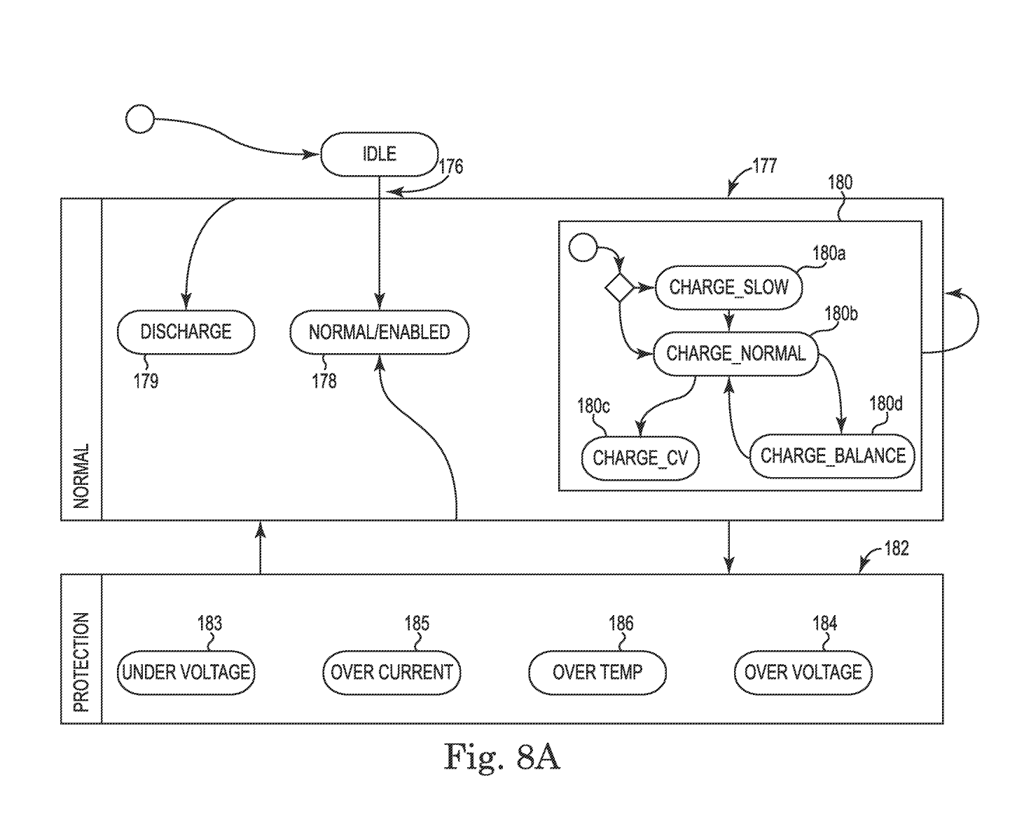

An exemplary embodiment of an enumeration sequence for the SMM 14 is diagrammed in FIG. 8. Upon initialization of the SMM at 150, multi-tiered sampling and storage or data is performed. Namely, the controller 100 can sample the BPM pack to retrieve pack voltage, temperatures and current data at step 152. Collection of BPM status, voltages, temperature and like data can be performed at step 154. The pack samples are readied at 156 and the BPM data is readied at 158. The last cell voltage, temperature and other data for the pack is updated at step 160, and the BPM image and/or status is updated at step 162. In certain embodiments, each of the steps 160, 162 must be completed before proceeding to the next processing event.

Upon updating the pack and BPM data, the processor 100 can process the data at 164 to generate appropriate outputs, and can verify if the system is in a charge, discharge, or idle state or mode, or if the user changed any control limits or a power mode policy for the BPMs or system 10. In various embodiments, the processor can consequently direct drive outputs 170, such as directing the system to charge or discharge the batteries. The processor 100 can also update the BPM health status at step 172. Again, if needed, the SMM processor 100 can send fault record data, update the BPM health data, or control the balance resistor at step 174. In general, the processor 100 runs through the above-enumerated steps periodically—e.g., approximately every one second in various embodiments. The timing is configurable and can vary greatly depending on the particular application needs and data involved.

From the temperature data and passive thermal management reported by each BPM 12, the SMM 14 can also control the temperature for the complete battery pack.

The SMM 14 can dynamically modify under- and over-voltages whenever a new BPM 12 is added in series to the existing modules. The SMM 14 can dynamically modify the current limits whenever a full parallel set or stack of BPMs are added or removed. This configuration can require a different enumeration process or sequence, similar to the plug and play protocol of USB wired communications. For instance, when a new BPM is installed it would send an identification message to the SMM via the line 15, which would then accept or reject the BPM.

The SMM 14 can dynamically modify control limits while in operation. For instance, the SMM 14, at the processor 100, automatically recognizes the need to change control limits and will propagate the new control limits to all BPMs. This can occur when an adverse event has been detected of where a system component has degraded or is not functioning.

Further, the SMM 14 communicates to the battery user the complete status and health of all the individual power modules using the computer or mobile interfaces, or an integrated display (e.g., LCD), via wired or wireless interface protocols.

In certain embodiments, the user 11 interacts with the system in a relatively limited manner, such as viewing various parameters, performance, or to engage in relatively minimal configuration actions with the system 10 (SMM and/or BPM) via the port 21, or other wired or wireless communication lines. The displaying of data and operating parameters, and performance information, can be provided to the user 11 much like a fuel gauge in a vehicle—primarily for monitoring and setting general modes of operation. The features and use cases can be performed via the software and/or hardware detailed herein. The following table provides exemplary features, terminology, and use cases for these types of user interactions with the system 10.

| Feature/Use Case ID | Feature/Use Case Description |
|---|---|
| User Mode Policy | The user can select from several user profiles - performance, |
| | economy, long life. Performance or sport mode allows the most |
| | extreme discharge rates and the longest discharge times. This will |
| | have the shortest life though. The Economy profile will not allow |
| | extreme discharge rates and is designed to have long discharge |
| | periods. The long life profile will allow extreme discharge rates and |
| | will not have long discharge periods. |
| Run Time Data, | Allow the user to view system parameters and metrics - battery |
| Diagnostics | cell/pack voltages, temperatures, current, state of charge, |
| | remaining time left, etc. Diagnostics allow the user to see ratings for |
| | the BPMs (good, ok, bad) and any fault reports. |
| Charge, Discharge, Idle | These are some of the system states that the SMM must infer from |
| | various sensors. It is important for the SMM to know whether a |
| | load or charger is hooked up, and if idle, or active. |
| Report Faults, Errors | The SMM can disable the battery from working, by allowing no |
| | current to flow. SMMs may also have a Buzzer, LEDs, or LCDs |
| | installed that can indicate problems to the user. The system also |
| | records faults to non-volatile memory. |

As noted above, the sport mode provides increased but short-term performance. The battery can be permitted by the system 10 to be fully discharged from 100% to 0%. This translates to a higher upper voltage limit and a lower voltage limit. Larger currents and temperatures would be allowed. Longer time values to qualify events would be used—e.g., an over-current event occurs if the current is above the over-current control limit for 30 seconds instead of the typical 1 second.

In other embodiments, the user 11 will interact greatly with the system to view, retrieve system data, update, and analyze and configure parameters and limits of the system 10. Again the system interaction can occur via a personal computer, mobile device, and the like, with wireless or wired communication at port 21. The features and use cases can be performed via the software and/or hardware detailed herein. The following table provides exemplary features, terminology, and use cases for such user interactions with the SMM 14 or system 10.

| Feature/Use Case ID | Feature/Use Case Description |
|---|---|
| Calibrate/Test BPM(s) | Calibrate the Capacity (SOH) of a BPM. One method requires a full |
| | charge/discharge of the BPM. The results would be stored in each |
| | BPM that is calibrated. |
| Calibrate/Test ADC | Calibrate an ADC port of the SMM. The results would be stored in |
| | the ADC configuration memory of the SMM. |
| Configure System | This allows the user to configure or reconfigure the number and/or |
| <static> | type of BPMs in a pack. The number of BPMs of the same type can |
| | be adjusted to modify the voltage of a battery pack (e.g., 24 V to |
| | 36 V). The user will enter into a form the SMM serial number, the |
| | BPM type, and the number of BPMs for communication to the SMM |
| | for processing and use at the processor of the SMM. |
| Firmware Update | Load new firmware into the SMM via USB port or wirelessly. The PC |
| | or mobile device software/app can verify that the new firmware |
| | version is compatible with the SMM hardware version and the BPM |
| | hw/sw version. |
| View BPM | The BPM has and stores numerous types of information - current |
| status/records | status and measurements (cell voltage, temperature), fault/failure |
| | records, health records, and control limits. |
| View/Set Control Limits | The user can view or set system control limits at any time. These are |
| | generally stored on the BPMs via line 15, but the SMM can be |
| | ultimately responsible for enforcing the control limits by enabling or |
| | disabling current to flow through the pack, or by cell balancing. |

The following table provides additional exemplary features, terminology, and use cases for one or more SMMs 14 of the system 10. The features and use cases can be performed via the software and/or hardware detailed herein.

| Feature/Use Case ID | Feature/Use Case Description |
|---|---|
| Power Mode Policy | This is related to the User Mode Policy, but handles the goals at a |
| | lower layer. |
| Configure System | This feature allows the user to “plug and play” BPMs into the |
| <dynamic> | system, much like USB. The BPM would register with the SMM and |
| | request to join the battery pack. |
| BIT | Built In Test. There are various types - initiated (IBIT), periodic |
| | (PBIT), continuous (CBIT), power up (PUPBIT). |
| USB | The SMM supports a USB interface, intended to connect with a |
| | personal computer. |
| BT 4.0 BLE | The SMM supports a Bluetooth (e.g., 4.0) low energy interface. |
| SMM Initialization | Initializes the SMM hardware and software resources. Performed |
| | after power up. |
| System Initialization | Attempts to connect to all configured BPMs. Will enable each |
| | connected BPM. |
| Monitor Pack V, I, & T | Monitor battery pack (from most negative battery terminal to most |
| | positive battery terminal) voltage, temperature, and current. |
| | Measures current in charge and discharge directions. |
| Collect * From BPM | Can be a fault record, a control limit, a health/life record, BPM data |
| | (cell voltage, temperature), BPM status. |
| Validate BPM's - data, | Heartbeat means that all BPM requests must be performed within a |
| heartbeat | certain period of time. The sum of reported BPM cell voltages |
| | should be within tolerance of the SMM measured pack voltage. |
| Send * To BPM | Can be a fault record, a control limit, a health/life record, or |
| | command to a BPM (turn balance resistor on/off). |
| I2C | The communication line to the set of BPMs. |
| Protection Algorithms | Protect for over-voltage, under-voltage, over-temperature, over- |
| | current, etc. Can be state dependent (e.g., charge, discharge, idle, |
| | standby). |
| System State | Charge, discharge, idle, standby. |
| Estimate - SOC, SOH, | SOC - State of Charge. SOH - State of Health. SOC is the % charge |
| Cycle Life | left within a current discharge cycle. SOH is the current capacity of |
| | the battery. |
| Modify BPM Limits per | The battery cells within a battery pack should not exceed the limits |
| Worst BPM | of the weakest battery cell. When determined necessary, the SMM |
| | will modify the pack control limits and the BPM control limits to |
| | ensure compliance to safety and performance goals. |
| Rate BPM's | Based on SOH of a BPM, following ratings: OK, suspect, and |
| | bad/replace. |
| Charger Detection | Can be detected by measuring current or a special hardware circuit. |
| Load Detection | Can be detected by measuring current or a special hardware circuit. |

Referring to FIG. 8A, embodiments of the SMM 14 of the present invention can have three operating modes: initialization, normal, and protection. Upon power-up the SMM 14 enters initialization mode 176, which contains the initialization/idle state. In general, if there are no negative issues during initialization, the SMM 14 will transition to the normal mode 177. If negative issues are encountered (e.g., a BPM 12 in the pack did not respond), the SMM 14 will remain in the initialization/idle state.

The normal mode 177 can include three states—normal/enabled 178, discharge 179, and charge 180. While in normal mode, the SMM 14 can freely switch between the three states. Generally, the SMM 14 will be in normal/enabled state 178 when there is no active load or charger on the system 10. For instance, a load or charge may be installed, but not active. The SMM 14 will be in discharge state 179 when a load is installed and the battery is being actively discharged. The SMM 14 will be in the charge state 180 when the battery is being actively charged by the charger 27. “Actively” charging or discharging is when the current is beyond self-discharge or stand-by current levels.

While in the normal/enabled state 178, both charge and discharge field-effect transistors (FET) are turned on, so that current may flow in either direction, due to a load or charger. If a charger is detected by sensing a charging circuit, the SMM 14 transitions to the charging state 180. If a load is detected, the SMM 14 transitions to the discharging state 179.

The charging state 180 is a composite state, containing several sub-states including charge_slow 180a, charge_normal 180b, charge_CV 180c, and charge_balance 180d. Upon entry to the charging state, the voltage of each battery cell is considered. If any battery cells are sensed to be extremely discharged, then the charge_slow 180a sub-state will be entered—e.g., small current to flow through the battery pack, to slowly and safely bring the voltage up to a safe level for charging. If all battery cells are of sufficient voltage, then the charge_normal 180b sub-state will be entered. Charge_CV 180c provides constant voltage. The SMM 14 can pulse-width modulate the voltage (e.g., when the charger voltage is larger than the voltage of the combined battery pack) applied by the charger 27 to generate the proper constant voltage for this sub-state. Once the level is reached, the SMM 14 transitions to the charge_normal 180b state.

While in the charge_balance 180d sub-state, the SMM 14 turns off both the charge FET and discharge FET to prevent any current flow. The balancing resistor is turned on at the proper cell, to bleed off excessive voltage. Once enough voltage has been discharged, the SMM 14 transitions back to the charge_normal sub-state 180b, where the charge and discharge FETs are turned back on. The SMM 14 can go through this process several times, for several cells, during the charging process.

While in normal 177 mode, the SMM 144 is continuously monitoring for protection events (e.g., adverse events) at its inputs and/or sensors in a protection mode 182. Protection states within the protection mode include, under-voltage 183, over-voltage 184, over-current 185, over-temperature 186, etc. If a protection event is detected, the SMM 14 immediately transitions to the protection mode 182. In general, either the charge or discharge FETs, or both, will be turned off by the SMM to stop current. The SMM can then determine and provide instructions to exit the various protection states. To exit the under-voltage state 193, a charger will need to be connected to the system 10. To exit the over-voltage state 184, all cell voltages must return to within normal limits. To exit the over-temp state 186, all temperature readings must return to normal limits. Again, operating or control limits for the BPMs are stored and can be updated. To exit the over-current state, all current measurements must be less than idle/standby.

FIG. 7B is a block diagram of an embodiment of the present invention wherein the SMM 14 performs its typical hardware and software functions, as well as those of one or more BMPs 12. The SMM 14 is provided in operative communication with and control of the battery modules and cells of the pack. The SMM 14 directly senses and receives inputs from the cells of the pack, and performs any of the features, controls and outputs described herein for individual BMPs 12 and/or SMMs 14. The various user interactions, configurability, dynamic adjustability, and other aspects of the invention described and depicted herein for embodiments having BPMs and an SMM are likewise included and are a part of this embodiment that does not include distributed BPMs.

### User Interface and Configuration

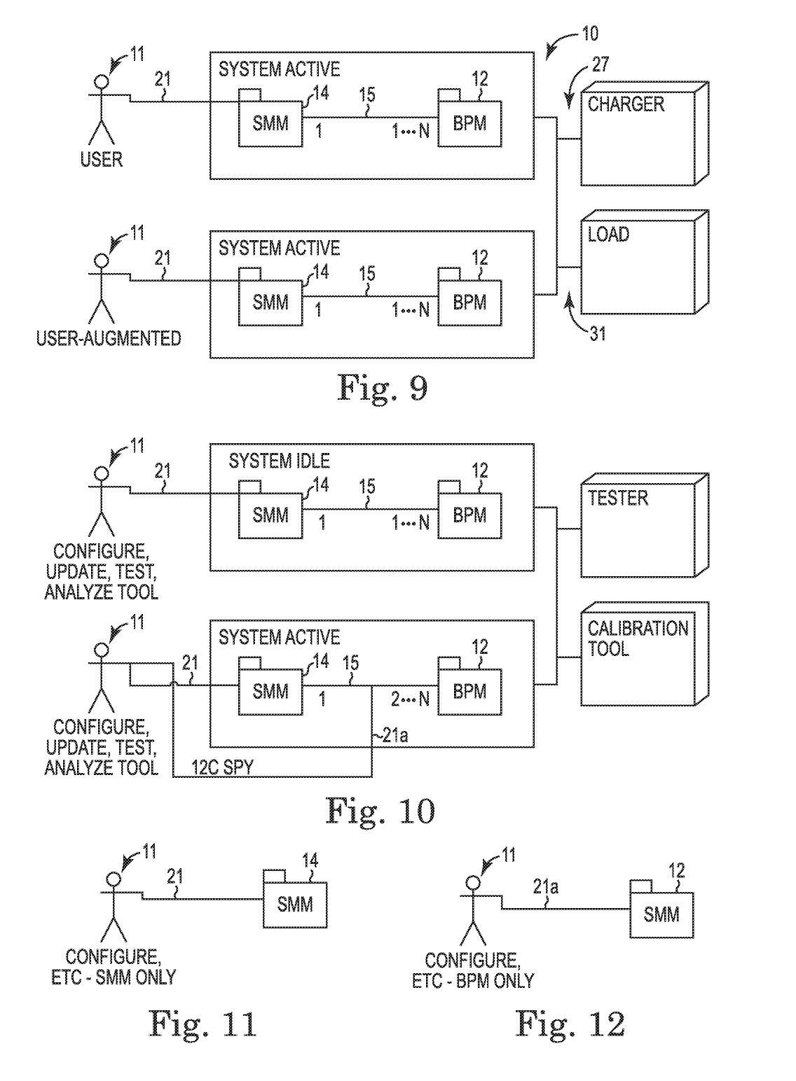

FIGS. 9-12 show various embodiments where the user 11 interacts at varying levels with the system 10. The user can simply use the system with minimal interaction or configuration input, or the user can interact greatly via the devices and methods described (including the features and use cases) herein to extensively monitor and configure specific aspects and parameters of the system 10.

A software application, or hardware logic, installed on a personal computer, a mobile device, or a remote server can communicate through a wired (e.g., USB, Ethernet, etc.) or wireless interface (e.g., Bluetooth, Wi-Fi) with the SMM, or the BPMs directly in certain embodiments, to provide useful information to the user, dealer, repair center and manufacturer. The user connectivity and interface can further allow the user to selectively control and configure the system 10.

FIG. 9 shows a level of user interactivity with the system 10 that can involve a simple use case where the user 11 simply uses the system (e.g., charging, and to power LEV or e-bike) without reference control or configurability. Alternatively, the user 11 can engage the system as described herein to view certain system parameters and metrics like a fuel gauge, or to set user profiles or mode policy (e.g., performance or economy modes). A smart charger 27 with a communication port in operative communication with the SMM can receive commands from the SMM. The SMM can configure settings and control for constant current voltage to terminate constant current, constant voltage, and taper current.

FIGS. 10-12 show a level of interactivity with the system 10 where the user 11 can actively configure, update, analyze and test the various aspects, parameters, and metrics of the system 10, as described in detail herein. The user 11 can interact or engage with the system 10 via communication with the SMM (via port 21), or the BPMs directly (via 21a), as shown in FIGS. 10 and 12. The “tester” depicted in FIG. 10 can include a piece of automated test equipment, which would be under the control of the personal computer in operative communication with the system 10 via port 21. It can simulate real life conditions that a battery would experience. The calibration tool depicted in FIG. 10 can include a simple resistive load, a tool with electronics and/or software to generate a constant current, or a tool/device with a communication port (including those described herein with the personal computer or mobile devices).

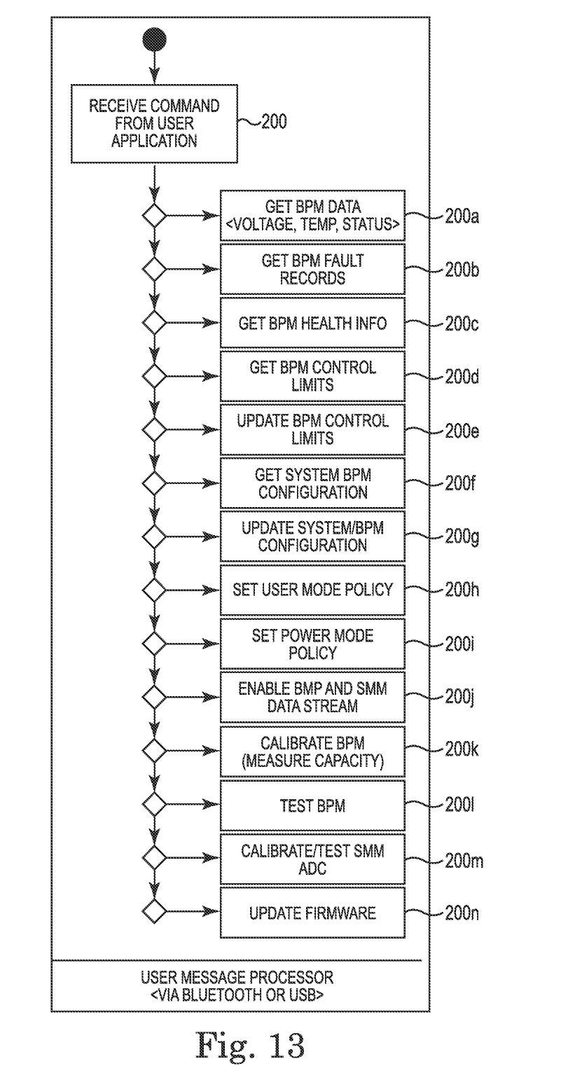

As demonstrated in FIG. 13, the SMM 14 can receive a command 200 from an external user software application and device 23a, 23b, or 23c (e.g., via USB from a personal computer, Bluetooth from a mobile or like device, or Ethernet or other internet connection from a cloud server) at port 21. The external user command 200 can include a myriad of send, store/save, and configuration commands for the system 10. For instance, the command 200 can include a request 200a for the SMM to send BPM data (e.g., voltage, temp and status), a request 200b for the BPM fault records, a request 200c for the BPM health information or status (e.g., SOH), a request 200d for the BMP control limits, instructions 200e to update the BPM control limits with new information or data, a request 200f for system/BMP configuration data, instructions 200g to update the system/BMP configuration with new information or data, instructions 200h to set the user mode policy, instructions 200i to set the power mode policy, instructions 200j to enable BPM and SMM data stream to the device or a remote server, instructions 200k to calibrate the BPM (e.g., measure capacity), instructions 2001 to test the BPM, instructions 200m to calibrate or test the SMM ADC (analog-to-digital converter), or instructions 200n to update the firmware on the SMM. Other send, store and/or process and configuration instructions via the port 21 to the SMM are envisioned and can be employed within the system 10 without deviating from the scope of the present invention. Further, the SMM can pass applicable instructions, updates, and configuration settings or data on to the operatively connected BPMs via the line 15.

An extended protection system (EPS) of the present invention is uniquely configured to work with battery cells (in multiple BPMs) of mixed ages and/or capacity. Fine testing and physical matching of cells, which is conventionally a prerequisite for long life in a battery pack, is not needed when the present system 10 is utilized, as it expects cells/modules that will not be exactly matched over the life of a battery pack. The SMM 14 (e.g., the processor 100 of the controller) stops battery pack charging when the first cell or BPM voltage reaches a calculated peak voltage detected. The balancing resistor(s) for passive balancing or the active cell balancing will then reduce peak voltages where needed. Instructions or outputs will then be sent for charging to resume if there are cells/modules that will perform better with a higher voltage state of charge. This process will continue until optimum balancing is achieved.

Stored protection profiles are then implemented to meet individual user needs and/or settings. These profiles include Maximum Amp-Hour and extended life settings. Battery cell life can be extended if the maximum charge voltage is reduced and/or if the minimum discharge voltage is increased. An example would be where the user with an LEV purchases a 20 AH battery even though his daily commute will only use 16 AH per day. The rational is that at the end of a year the battery will only output 80% (estimated degradation) of original capacity and the user will still need the 16 AH per day after one year. Executing a stored extended life profile, the SMM 14 will charge the battery to a lower peak voltage and stop the discharging sooner, providing just over the 16 AH capacity needed for the commute, which would result in extending the battery pack life by several days or even months before the 80% of original capacity is realized. The user can adjust the protection profile by utilizing and configuring the system 10 via the information interface for users described herein. On the weekend the user in this example might want full use of the maximum amp-hour capacity and by simply changing the setting before charging, it would be available to the user.

In certain embodiments, The SMM 14 can scale when needed for connecting up to 64,000 BPMs and/or 255 additional SMMs in one large battery pack. Other configurations and total BPM 12, battery cells, and SMM 14 numbers and aggregations can be employed without deviating from the scope of the present invention.

### Remote Database

Information stored in an Internet server side database (e.g., via cloud server 25), or remotely on a digital network, provides information on and/or to the BPMs and SMMs throughout their life cycles, as well as other system 10 information. The ability to track module performance by the manufacturing lot number or other variables can provide valuable information for continuous quality improvement of the BPMs, SMMs, and the overall system 10. In certain embodiments, the server 25 can be operatively connected to the system 10 directly through an Ethernet or other connection at port 21, or via a personal computer 23a or mobile device 23b.

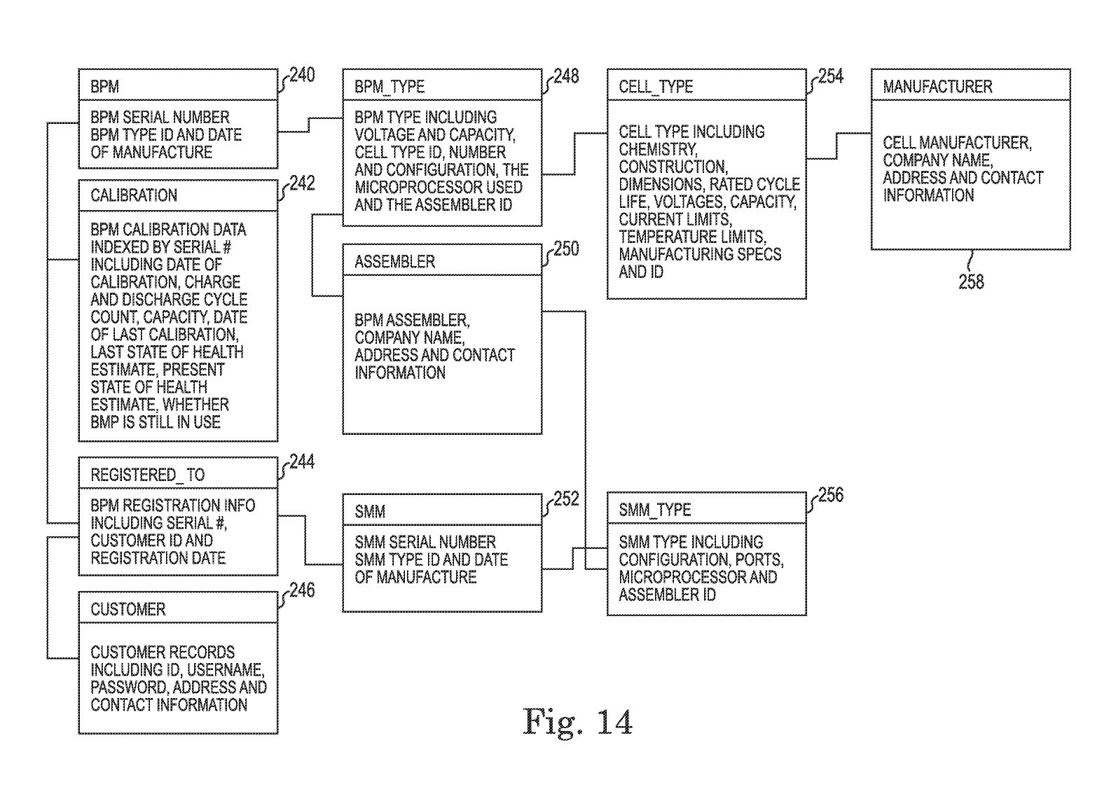

As demonstrated in FIG. 14, the server side database can receive, store, and process various data regarding and/or received from the BPMs and/or the SMMs in operative communication with the system, including BPM data 240, calibration update data 242, registration data 244, customer data 246, BPM type data 248, BPM assembler data 250, SMM data 252, cell type data 254, SMM type data 256, cell manufacturer data 258, and the like.

The BPM data 240 can include the serial numbers, type ID, and date of manufacture of the various BMPs in the system 10. The calibration update data 242 can include BPM calibration data, indexed by various metrics and variable, including serial number, data of calibration, charge and discharge cycle count, capacity, data of last calibration, last state of health estimate, present state of health estimate, and whether a particular BMP is still in use. The registration data 244 can include BPM registration information, including serial number, customer ID, and registration data for the BPMs.

The customer data 246 can include customer records, including customer ID, username, password, address and other contact information. The BPM type data 248 can include voltage and capacity for the BPM, the cell type ID, the number and configuration of the BPM, the microprocessor used, and the assembler ID. The assembler data 250 can include the BPM assembler company name, and the address and contact information of that company.

The SMM data 252 can include the SMM serial number, SMM type ID, and the date of the manufacture of the SMM. The cell type 254 can include the chemistry, construction, dimensions, rated cycle, life, voltages, capacity, current limits, temperature limits, manufacture specs and ID for the various cells in the system 10. The SMM type data 256 can include the configuration, ports, microprocessor, and assembler ID for the SMM. The cell manufacture data 258 can include the cell manufacturer, company name, and address and contact information for the company.

Other various ID, control limit, manufacturer, assembler, BPM and SSM type and configuration data can be stored, modified and retrieved for use with the system 10, without deviating from the scope of the present invention.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A distributed battery management system, comprising:
a first battery module including one or more battery cells;
a first battery controller provided in operative communication with the first battery module and including a first processor and a first non-volatile memory;
a second battery module including one or more battery cells; and
a second battery controller provided in operative communication with the second battery module and including a second processor and a second non-volatile memory.

2. The system of claim 1, wherein the first battery controller monitors at the first processor and stores in the first non-volatile memory the number of charge cycles and the max voltage of the first battery module.

3. The system of claim 2, wherein the first battery controller further monitors at the first processor and stores in the first non-volatile memory the maximum or minimum operating temperature of the first battery module.

4. The system of claim 1, wherein the second battery controller monitors at the second processor and stores in the second non-volatile memory the number of charge cycles and the max voltage of the second battery module.

5. The system of claim 4, wherein the second battery controller further monitors at the second processor and stores in the second non-volatile memory the maximum or minimum operating temperature of the second battery module.

6. The system of claim 1, wherein at least the the first battery module is adapted to monitor and process adverse events to protect at least the first battery module.

7. The system of claim 6, wherein the adverse events include data related to voltage, temperature, or current.

8. The system of claim 1, further including a management control module including a processor and non-volatile memory, the management control module provided in operative communication with the first battery controller and the second battery controller.

9. The system of claim 8, wherein the management control module is selectively configurable via user application software.

10. The system of claim 8, further including a remote server database in operative communication with the management control module to transfer to and store identification data, health records, or fault records on the remote server database for at least the first and second battery modules.

11. The system of claim 1, further including a charger configured to charge the first and second battery modules.

12. The system of claim 1, wherein the first and second battery modules are configured to power, at least in part, a light electric vehicle or an electric bike.

13. A distributed battery and management system, comprising:
a plurality of battery modules, each including one or more battery cells and a battery controller having a processor and a non-volatile memory; and
a management control module including a processor and a non-volatile memory, the management control module provided in operative communication with and configured to selectively control each of the plurality of battery modules.

14. The system of claim 13, wherein each of the plurality of battery modules store in the non-volatile memory of the battery controller the number of charge cycles and minimum and maximum voltage operating limits for the battery module.

15. The system of claim 13, wherein each of the plurality of battery modules store in the non-volatile memory of the battery controller a maximum or minimum operating temperature limit for the battery module.

16. The system of claim 13, wherein each of the plurality of battery modules store in the non-volatile memory of the battery controller dynamic records data for the battery module.

17. The system of claim 16, wherein the dynamic records data can include state of charge, state of health, and a cycle life data for the battery module.

18. The system of claim 13, wherein the management control module is selectively configurable via user application software.

19. The system of claim 13, further including a remote server database in operative communication with the management control module to transfer to and store identification data, health records, or fault records on the remote server database for the plurality of battery modules.

20. The system of claim 13, wherein the management control module is in operative communication with a power source to maintain optimal voltage for the plurality of battery modules.
